(19) United States
(12) Patent Application Publication
(10) Pub. No.: US 2012/0073493 A1
(43) Pub. Date: Mar. 29, 2012

(54) Indicator Assembly for Liquid Level

(76) Inventor: Herbert G. Ross, JR., Argyle, TX (US)

(21) Appl. No.: 13/242,625

(22) Filed: Sep. 23, 2011

Related U.S. Application Data
(60) Provisional application No. 61/385,950, filed on Sep. 23, 2010.

(51) Int. Cl. G01F 23/00

(52) U.S. Cl. 116/227

(57) ABSTRACT

An indicator assembly for displaying either low liquid level or satisfactory liquid level conditions within a tank includes a sensor for detecting the liquid level conditions, a photodetector for detecting an ambient dark condition, a pair of indicator lights for indicating either the low liquid level or satisfactory liquid level conditions, and electrical circuitry operable to illuminate one of the indicator lights upon detection of the ambient dark condition by the photodetector and detection of either the low liquid level condition or satisfactory liquid level condition by the sensor. A solar panel is also provided for recharging a power supply operably connected to the electrical circuitry.

### CROSS-REFERENCE TO RELATED APPLICATIONS

This application claims the benefit of U.S. Provisional Application No. 61/385,950 filed on Sep. 23, 2010, the disclosure of which is hereby incorporated by reference.

### BACKGROUND OF THE INVENTION

This invention relates to monitoring liquid level in tanks, and more particularly to a system and method for indicating a liquid level condition within a tank.

The determination of liquid level within LPG or fuel oil tanks is typically performed by a mechanical float-type gauge that extends into the tank. One type of gauge is disclosed in U.S. Pat. No. 6,041,650 to Swindler, et al., and includes a movable float arm coupled by gears to the lower end of a rotatable shaft. A magnet is mounted to the upper end of the shaft and extends into a passage of a gauge head for magnetic coupling with a level indicating dial. A change in liquid level within the tank causes movement of the float arm and thus rotation of the indicating dial to thereby show the amount of liquid within the tank.

Although the above-described system is adequate for indicating liquid level, it is often inconvenient for will-call status customers, i.e. those that must call a fuel supply company for tank refill, to read the gauge head. For stationary tanks, a person must exit the building, approach the tank and move a cover that extends over the gauge head and other fittings in order to ascertain whether or not a fuel supply company should be contacted for refilling the tank. Consequently, many stationary tanks run out of fuel at the most inconvenient times, such as during heating, cooking, bathing, and so on. However, such inconveniences pale in comparison to potentially more serious consequences, such as frozen pipes during winter conditions and the attendant damage and repair costs, health degradation among the young, elderly, sick and invalid when exposed to low temperature conditions, and so on. The difficulty in ascertaining fuel level within the tank is exacerbated during harsh winter months where the desire or effort to read the gauge is dampened, especially when ice or snow is present, or simply at any time when one feels that weather conditions are unfavorable for such a task.

Accordingly, there is a need to facilitate the determination of a low liquid level condition within a fuel tank or the like from a remote location, such as from a window inside a home or other convenient viewing location, in time for an observer to alert a fuel provider of the need to refill the tank.

### BRIEF SUMMARY OF THE INVENTION

According to one aspect of the invention, an indicator assembly for displaying a liquid level condition within a tank is provided. The indicator assembly includes a sensor for detecting at least one of a first liquid level condition and a second liquid level condition, the first liquid level condition occurring at a predetermined low liquid level within the tank and the second liquid level condition occurring at a liquid level above the first liquid level condition; a photodetector for detecting at least an ambient dark condition, a first indicator light for indicating at least one of the first and second liquid level conditions; electrical circuitry electrically connected to the sensor, the photodetector and the first indicator light, the electrical circuitry being operable to illuminate the first indicator light upon detection of the ambient dark condition by the photodetector and detection of one of the first and second liquid level conditions by the sensor; at least one battery electrically connected to the electrical circuitry, and a solar panel operably associated with the at least one battery for charging the battery.

According to a further aspect of the invention, an indicator assembly for displaying a liquid level condition within a tank includes a base portion, an upright portion extending from the base portion, an upper housing portion connected to the upright portion, and electrical circuitry located within the upper housing portion. The electrical circuitry includes at least one indicator light for displaying a liquid level condition. A battery compartment is located on the upper housing portion and at least one battery is located in the battery compartment for providing electrical power to the electrical circuitry. A solar panel is positioned on the upper housing portion for supplying charging current to the at least one battery. A position sensor is actuable when the liquid level condition within the tank reaches a predetermined level. The position sensor is operably associated with the electrical circuitry for illuminating the at least one indicator light when the predetermined level has been reached.

### BRIEF DESCRIPTION OF THE DRAWINGS

The foregoing summary as well as the following detailed description of the preferred embodiments of the present invention will be best understood when considered in conjunction with the accompanying drawings, wherein like designations denote like elements throughout the drawings, and wherein:

FIG. 1 is a front elevational view of an indicator assembly for displaying liquid level mounted on a tank in accordance with the invention;

FIG. 2 is a front perspective view of the indicator of FIG. 1;

FIG. 3 is a bottom rear exploded perspective view of the indicator assembly;

FIG. 4 is a top front exploded perspective view of the indicator assembly; and

FIG. 5 is a sectional view of the indicator assembly taken along line 5-5 of FIG. 2.

It is noted that the drawings are intended to depict only typical embodiments of the invention and therefore should not be considered as limiting the scope thereof. It is further noted that the drawings may not be necessarily to scale. The invention will now be described in greater detail with reference to the accompanying drawings.

### DETAILED DESCRIPTION OF THE INVENTION

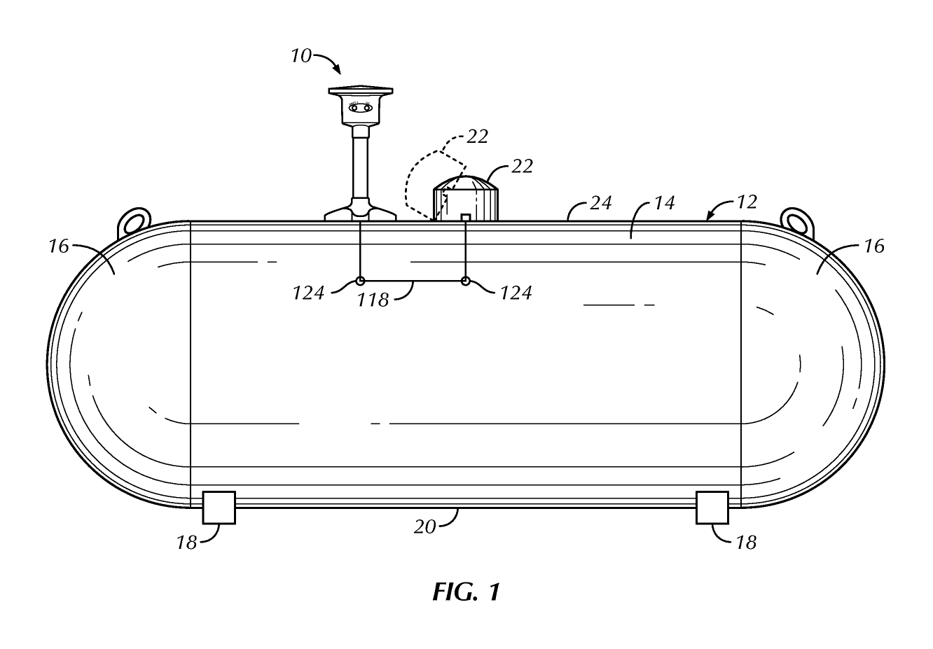

Referring to the drawings, and to FIG. 1 in particular, an indicator assembly 10 for displaying liquid level within a tank 12 in accordance with the present invention is illustrated. The tank 12 as shown includes a generally tubular tank portion 14 integrally connected to generally semi-spherical end portions 16 in a hermetically sealed arrangement. Feet or legs 18 are provided at the bottom 20 of the tank 12 for supporting the tank, while a cover 22 is hingedly connected to the top 24 of the tank to alternatively protect and expose various tank components, such as a gauge head dial, filling valves and/or pressure relief valves (not shown), and other well-known tank components. The tank 12 is especially suited for delivering combustible gas, such as light propane gas (LPG) or the like, under pressure to a remote location, such as a water heater, stove, furnace, and so on.

Although the indicator assembly 10 can be mounted at any position or orientation with respect to the tank 12, it is preferred that the indicator assembly be mounted generally at the top 24 of the tank behind the cover 22 at a sufficient distance to allow opening of the cover without interference, as illustrated by dashed line in FIG. 1. Placement of the indicator assembly 10 behind the cover 22 also deters damage to the indicator assembly during tank filling or servicing. Although the indicator assembly 10 of the present invention is particularly advantageous when used in conjunction with outdoor LPG tanks, it will be understood that other tank types and/or shapes can be used, and that the level of other liquids can be detected and displayed.

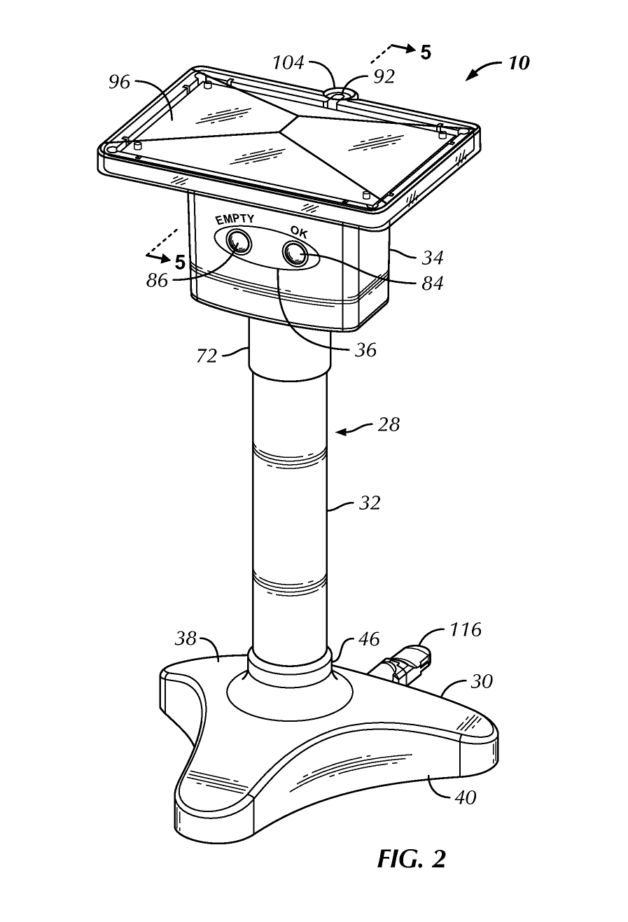

With reference now to FIGS. 2-5, the indicator assembly 10 preferably includes a housing 28 comprising a base portion 30, a tubular upright portion 32 extending from the base portion 30, and an upper housing portion 34 connected to an upper end of the upright portion 32. The upper housing portion 34 preferably has a display section 36 denoting “empty” and “OK” conditions of the tank 12 (FIG. 1). However, it will be understood that other tank conditions can be displayed without departing from the spirit and scope of the invention.

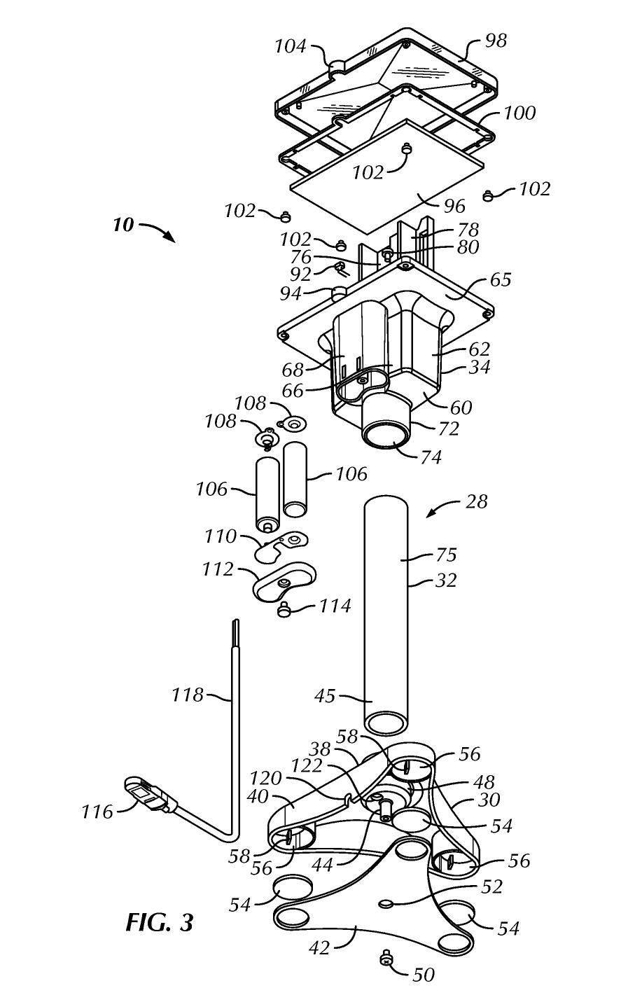

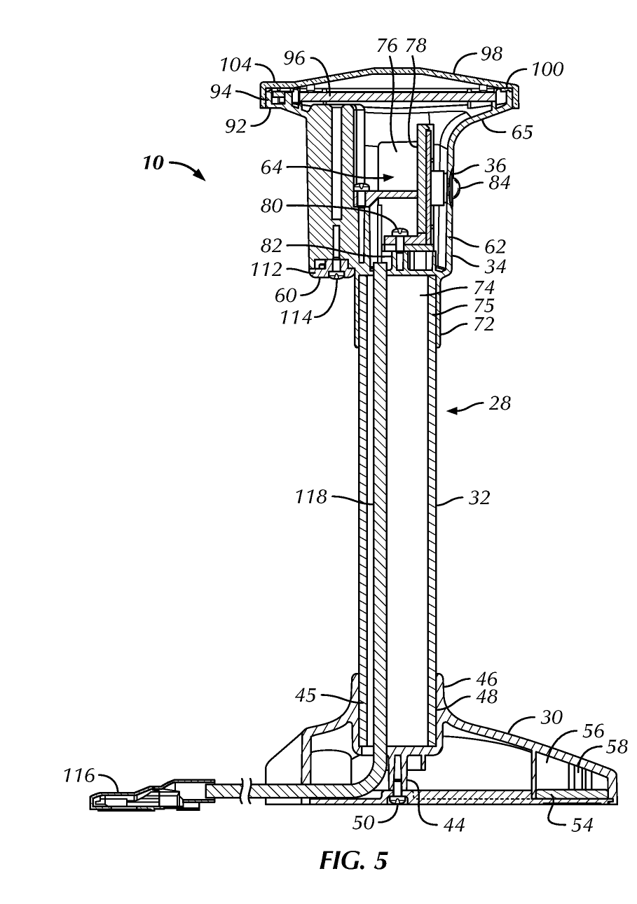

The base portion 30 is preferably generally triangular in shape with three legs 39 preferably oriented at approximately 120 degrees from each other. The base portion 30 preferably includes a top wall 38, a continuous side wall 40 extending downwardly from the top wall, and a bottom wall 42 connected to the side wall 40. An annular protrusion 46 extends upwardly from the top wall 38 and a cup-shaped depression 48 is formed in the protrusion for receiving a lower end 45 of the upright portion 32. The lower end of the upright portion can be attached to the depression 48 in any well-known manner, including but not limited to, adhesive bonding, mechanical fastening, interference fitting, cooperating threads, as well as other connecting means. A central boss 44 (FIGS. 3 and 5) extends downwardly from the depression 48 and is adapted to receive a fastener 50 that extends through an opening 52 of the bottom wall 42 for securing the bottom wall to the side wall 40. Magnets 54 are preferably positioned in hollow protrusions 56 formed in the side wall 40 for mounting the indicator assembly 10 to the tank 12. Each magnet 54 is sandwiched between a plurality of ribs 58 formed in each protrusion 56 and the bottom wall 42. Preferably, the base portion is shaped to conform to the tank 12 to minimize the gap between the magnets and the tank 12 so that the magnets have maximum holding power. It will be understood that the base portion 30 can be formed with more or less legs or can be formed of some other shape without departing from the spirit and scope of the invention.

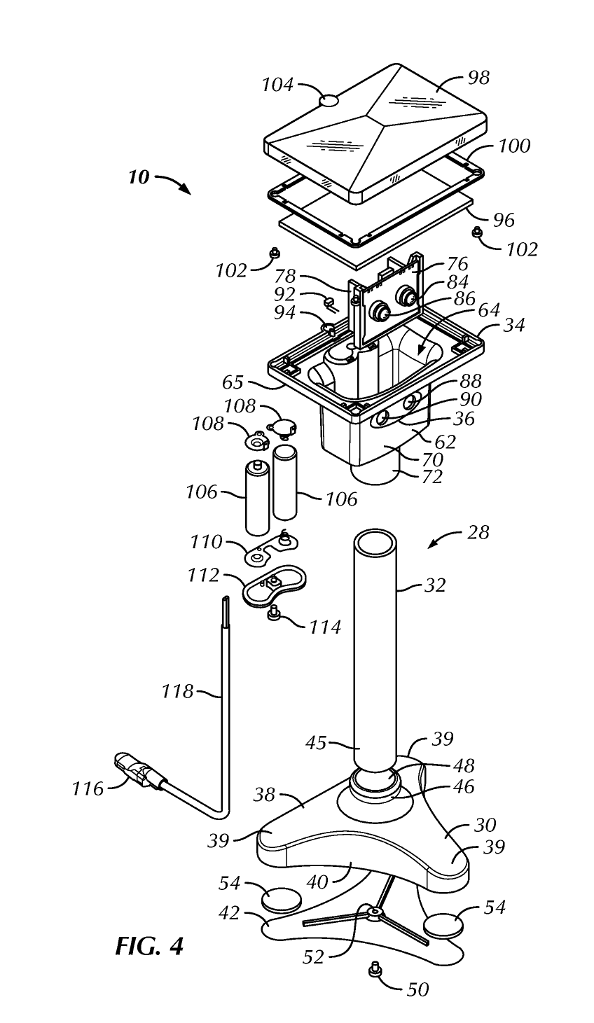

The upper housing portion 34 preferably includes a lower wall 60, a continuous side wall 62 that extends upwardly from the lower wall to form a hollow interior 64 (FIGS. 4, 5), and an upper platform 65 that extends outwardly from the side wall 62. A battery compartment 68 is formed on a rear section 66 of the side wall 62 (FIG. 3) while the display section 36 is formed on a front section 70 thereof. An annular protrusion 72 extends downwardly from the lower wall 60 and a cup-shaped depression 74 is formed in the protrusion 72 for receiving an upper end 75 of the upright portion 32. The upper end of the upright portion can be attached to the depression 74 in any well-known manner, including but not limited to, adhesive bonding, mechanical fastening, interference fitting, cooperating threads, as well as other connecting means.

In accordance with a further embodiment of the invention, the base portion 30, upright portion 32 and upper housing portion 34 may be integrally formed as a single unit through injection molding or other known manufacturing processes.

As best shown in FIGS. 4 and 5, a circuit board 76 containing electrical circuitry is preferably mounted in a bracket 78 which is in turn mounted in the hollow interior 64 of the upper housing portion 34. A threaded fastener 80 (FIG. 5) extends through the bracket 78 and into an upright boss 82 that extends upwardly from the lower wall 60 to hold the bracket and circuit board within the hollow interior.

The electrical circuitry preferably includes first and second indicator lights 84 and 86 that extend laterally from the circuit board 76 and through respective openings 88 and 90 formed in the display section 36. However, it will be understood that the indicator lights can also be recessed within the display section 36. The indicator lights are preferably of the high-intensity LED type. Although the size of the indicator lights can vary, it has been found that the larger variety, such as five and/or ten millimeter high intensity LED's, are adequate for determining the liquid level condition from a distance for many tank installations. Under normal operating conditions, it is anticipated that the first and second indicator lights will be seen at a distance up to 500 feet. Preferably, a conformal coating (not shown) is applied to the exposed side of the circuit board and the electrical components within the hollow interior 64 to protect the electronics from dirt, moisture, and other unfavorable environmental conditions.

A photodetector 92 is preferably located in a rear projection 94 of the upper platform 65 and is connected to the circuit board 76 for determining ambient light conditions. The photodetector 92 is preferably in the form of a CdS photoconductive cell that changes resistance in response to a change in light intensity. It will be understood that the present invention is not limited to the particular photodetector shown and described. In particular, other photodetectors, such as photodiodes, phototransistors, photovoltaic cells, and so on, may be used without departing from the spirit and scope of the present invention. When the resistance or other value of the photodetector 92 reaches a predetermined value, the electrical circuitry, which preferably includes a microcontroller and other related electrical components, determines that a dark condition has been met and the circuitry becomes operational to illuminate one of the indicator lights to inform an observer of the tank condition. Further details of suitable circuitry and a preferred method of displaying a liquid level condition within the tank 12 is disclosed in U.S. Pat. No. 7,079,037 to Ross, Jr. et al. on Jul. 18, 2006, the disclosure of which is hereby incorporated by reference in its entirety.

A solar panel 96 is installed on the upper platform 65. A protective transparent cover 98 is preferably installed over the solar panel and a gasket or seal 100 is sandwiched between the cover 98 and the platform 65 to protect the electronics against the ingress of moisture and contaminants. Fasteners 102 preferably extend through openings located in the corners of the platform 65, through the seal 100, and into the cover 98 for securing the assembly together. A lens 104 is formed in the cover 98 to accommodate the photodetector 92.

A power supply, shown as a pair of batteries 106 together with upper contact tabs 108 and lower contact tab 110 are located in the battery compartment 68. A door 112 receives the lower contact tab 110 and closes the battery compartment 68. A fastener 114 extends through the door 112 and into a boss located within the battery compartment for securing the components together. Preferably, the batteries 106 are of the rechargeable type, but may be single-charge replaceable batteries. The batteries 106 are electrically connected to the solar panel 96 for charging. The batteries 106 are also connected to the circuit board 76 for powering the electronics. Although a pair of batteries are shown, it will be understood that more or less batteries may be used. In accordance with a further embodiment of the invention, one or more electrical energy storage capacitors can be used to power the electronics or at least a portion thereof. Accordingly, the use of any suitable electrical energy storage device is contemplated.

With reference now to FIGS. 3, 4 and 5, a position sensor 116 is connected to the circuit board 76 via an electrical cable 118 that extends through the indicator housing 28. The cable 118 enters the housing 28 through a slot 120 (FIG. 3) formed in the side wall 40 of the base member 30 and an opening 122 formed in the upper wall 38 of the base member. Preferably, the opening 122 is of sufficient size to discourage the formation of condensation inside the housing 28, or when moisture may be present, to permit its drainage out of the housing. When the indicator assembly 10 is mounted to the tank 12, the electrical cable 118 can be secured to the tank by adhesive-backed cable ties 124 (FIG. 1) or other securing means.

The position sensor 116 is preferably a potted reed switch, with a permanent magnet (not shown) that keeps the reed switch in a normally closed state. The magnet couples with a liquid level gauge (not shown) mounted on the tank 12 to switch between open and closed positions depending on the rotational position of a magnetically driven pointer of the gauge dial. The magnetically driven pointer rotates in response to a change in liquid level within the tank in a well-known manner. A suitable gauge and switch combination is the Rochester Remote Ready Dial (R³D) and Reed Switch Module by Rochester Gauges, Inc. of Dallas, Tex. The remote ready dial includes a magnetic pointer that rotates between empty and full positions in response to float movement inside a tank. The reed switch snap-fits into a recess in a lens of the remote ready dial and can be adjusted to switch at a predetermined low liquid level. Preferably, the reed switch is in a normally closed state and opens when the magnetic pointer rotates to a position where its magnetic field opposes and offsets the magnetic field of the magnet in the proximity sensor 116, thereby causing the reed switch to open. It will be understood that the reed switch can alternatively be of the normally open type that closes in response to pointer position. It will be further understood that the position sensor 116 can be embodied as an optical switch, a mechanical contact switch, and so on. Alternatively, the position sensor may be embodied as a magnetic pick-up device, such as a hall-effect sensor, to monitor the relative magnetic field as the pointer moves toward or away from the sensor. A particular sensed field strength can then be used as an indication of low liquid level.

In order to illuminate the indicator lights when certain events have occurred, such as the detection of a low ambient light level for a predetermined time period and/or a low tank level, the electronics are programmed to switch on one of the lights. Conversely, when the predetermined time period has ended and/or when the low level condition no longer exists, one or both indicator lights can be switched off.

In order to conserve battery power, the electronics are preferably normally in a sleep mode, the indicator lights 84, 86 are normally off and the photodetector monitors ambient light. When the ambient light is less than the predetermined level, such as at night, the photodetector is in a high state, and the electronics are wakened from the sleep mode to display the tank condition.

In order to further conserve battery power, the indicator light reflective of tank condition can be flashed once every predetermined time period, such as twenty seconds, one minute, and so on, and for a preset display period, such as one hour, two hours, and so on. The flash time during each interval can be, for example, approximately 300 milliseconds, although the actual flash time can greatly vary. Alternatively, the indicator light may be held constantly on for the preset display period. Since the first indicator light 84 is a positive indication that the circuit is working properly and that no tank refilling is needed, it is preferable that the light 84 emits radiant energy at a wavelength in the visible green spectrum.

When the switch 116 is activated, the contents of the tank 12 are at a low liquid level condition. By way of example, the low liquid level condition can be reached when the liquid level is approximately 25 to 30 percent of a full tank. In this manner, a fuel supply company can be contacted for refilling the tank before the tank runs out of fuel. When it is determined that a low liquid level condition exists, the second indicator light 86 is illuminated. By way of example, the second indicator light 86 can be flashed once every fifteen seconds for a preset display period, such as one hour, in order to further conserve battery power. The flash time during each fifteen second interval can be, for example, approximately 500 milliseconds, although the actual flash time can greatly vary. Alternatively, the second indicator light may be held constantly on for the preset display period. Since the second indicator light 86 is a positive indication that the circuit is working properly and that tank refilling is needed, it is preferable that the light 86 emits radiant energy at a wavelength in the visible red spectrum.

If neither of the indicator lights is illuminated for the preset delay period, an observer may readily ascertain that the indicator 10 is nonfunctioning, and may contact the fuel provider, manufacturer, distributor and so on, to make necessary repairs or replacement.

It will be understood that the particular number of flashes, the frequency of the flashes, the duration of each flash, the display period, and the particular wavelength of the indicator lights can greatly vary. Moreover, a bi-color LED may take the place of the two separate LED's for indicating the liquid level condition.

It will be understood that terms of orientation and/or position as may be used throughout the specification, such as upper, lower, top, bottom, below, forward, downward, and so on, refer to relative, rather than absolute orientations and/or positions.

It will be appreciated by those skilled in the art that changes could be made to the embodiments described above without departing from the broad inventive concept thereof. Although the present invention has been described in conjunction with LPG and similar tanks, it will be understood that other tank types and/or shapes can be used, and that the level of other liquids can be detected and displayed in a similar manner. It will be understood, therefore, that this invention is not limited to the particular embodiments disclosed, but it is intended to cover modifications within the spirit and scope of the present invention as defined by the appended claims.

I claim:

1. An indicator assembly for displaying a liquid level condition within a tank, the indicator assembly comprising:
a sensor for detecting at least one of a first liquid level condition and a second liquid level condition, the first liquid level condition occurring at a predetermined low liquid level within the tank and the second liquid level condition occurring at a liquid level above the first liquid level condition;
a photodetector for detecting at least an ambient dark condition;
a first indicator light for indicating at least one of the first and second liquid level conditions;
electrical circuitry electrically connected to the sensor, the photodetector and the first indicator light, the electrical circuitry being operable to illuminate the first indicator light upon detection of the ambient dark condition by the photodetector and detection of one of the first and second liquid level conditions by the sensor;
a power supply electrically connected to the electrical circuitry; and
a solar panel operably associated with the power supply for charging the energy storage device.

2. An indicator assembly according to claim 1, and further comprising:
a base portion;
an upright portion extending from the base portion; and
an upper housing portion connected to the upright portion;
wherein the electrical circuitry is located within the upper housing portion, and the solar panel is positioned on the upper housing portion.

3. An indicator assembly according to claim 2, wherein the power supply comprises a battery.

4. An indicator assembly according to claim 3, and further comprising a battery compartment located on the upper housing portion, with the battery being positional in the battery compartment.

5. An indicator assembly according to claim 2, wherein the upper housing portion comprises a display section with a first opening, and further wherein the electrical circuitry comprises a circuit board mounted in a hollow interior of the upper housing portion, the first indicator light being mounted to the circuit board and extending laterally therefrom through the first opening.

6. An indicator assembly according to claim 5, and further comprising a second indicator light mounted to the circuit board and extending laterally therefrom through a second opening of the display section.

7. An indicator assembly according to claim 6, wherein the first indicator light projects radiant energy at a first visible wavelength to indicate a low liquid level condition of the tank.

8. An indicator assembly according to claim 7, wherein the second indicator light projects radiant energy at a second visible wavelength different from the first wavelength to indicate a liquid level condition above the low liquid level condition of the tank.

9. An indicator assembly according to claim 2, wherein the base portion includes a plurality of legs, each leg having a magnet connected therewith for magnetically mounting the indicator assembly to the tank.

10. An indicator for displaying a liquid level condition within a tank, the indicator comprising:
a base portion;
an upright portion extending from the base portion;
an upper housing portion connected to the upright portion;
electrical circuitry located within the upper housing portion, the electrical circuitry including at least one indicator light for displaying a liquid level condition;
a power supply electrically connectable to the electrical circuitry;
a solar panel positioned on the upper housing portion for supplying charging current to the power supply; and
a position sensor actuable when the liquid level condition within the tank reaches a predetermined level, the position sensor being operably associated with the electrical circuitry for illuminating the at least one indicator light when the predetermined level has been reached.

11. An indicator assembly according to claim 10, wherein the upper housing portion comprises a display section with a first opening, and further wherein the electrical circuitry comprises a circuit board mounted in a hollow interior of the upper housing portion, the first indicator light being mounted to the circuit board and extending laterally therefrom for projecting radiant energy through the first opening.

12. An indicator assembly according to claim 11, and further comprising a second indicator light mounted to the circuit board and extending laterally therefrom for projecting radiant energy through a second opening of the display section.

13. An indicator assembly according to claim 12, wherein the first indicator light projects radiant energy at a first visible wavelength to indicate a low liquid level condition of the tank.

14. An indicator assembly according to claim 13, wherein the second indicator light projects radiant energy at a second visible wavelength different from the first wavelength to indicate a liquid level condition above the low liquid level condition of the tank.

15. An indicator assembly according to claim 10, wherein the power supply comprises a battery.

16. An indicator assembly according to claim 15, and further comprising a battery compartment located on the upper housing portion, with the battery being positional in the battery compartment.

17. An indicator assembly according to claim 10, wherein the power supply comprises at least one energy storage capacitor.

18. An indicator assembly according to claim 10, wherein the base portion includes a plurality of legs, each leg having a magnet connected therewith for magnetically mounting the indicator assembly to the tank.
